(19) United States
(12) Patent Application Publication
(10) Pub. No.: US 2026/0136090 A1
(43) Pub. Date: May 14, 2026

(54) ACQUISITION METHOD OF IMAGE DATA TO BE USED IN SUITABILITY DETERMINATION OF DEFECTIVE FALL OF SCRAP, CREATION METHOD OF LEARNED MODEL USING IMAGE DATA ACQUIRED BY THE ACQUISITION METHOD

(71) Applicant: SUBARU CORPORATION, Tokyo (JP)

(72) Inventors: Daiki TABEI, Tokyo (JP); Yasunori SHIBATA, Tokyo (JP)

(21) Appl. No.: 19/265,642

(22) Filed: Jul. 10, 2025

(30) Foreign Application Priority Data
Sep. 17, 2024 (JP) 2024-159870

(51) Int. Cl. H04N 23/60; H04N 23/667

(52) U.S. Cl. CPC H04N 23/64; H04N 23/667

(57) ABSTRACT

An acquisition method of image data to be used in a suitability determination of a defective fall of a scrap cut off from a workpiece processed by a press die. The acquisition method causes a computer to perform simulation of operation in which a plurality of the scraps cut off from the workpiece are discharged to outside the press die through a scrap chute. The simulation includes: disposing cameras with respect to the respective scraps, in which the cameras are configured to capture the respective scraps; and before each of the scraps is discharged to outside the scrap chute, when a speed of any one of the scraps becomes zero, allowing an associated one of the cameras to capture the relevant one of the scraps, and allowing the computer to acquire the image data regarding the relevant one of the scraps.

### CROSS-REFERENCE TO RELATED APPLICATIONS

The present application claims priority from Japanese Patent Application No. 2024-159870 filed on Sep. 17, 2024, the entire contents of which are hereby incorporated by reference.

### BACKGROUND

The disclosure relates to an acquisition method of image data to be used in a suitability determination of a defective fall of a scrap, a creation method of a learned model using the image data acquired by the acquisition method, and a learned model created by the creation method. In particular, the disclosure relates to an acquisition method of image data and a creation method of a learned model using simulation in which a scrap is made to fall into a scrap chute.

In a manufacturing process of press products, a trimming process is performed. In the trimming process, a workpiece as a plate material is drawn by a press die provided in a press apparatus, and a scrap portion of the workpiece is cut and discarded. The scrap cut in the trimming process is discharged to the outside of the press die through a scrap chute of the press apparatus. At this occasion, a defective fall of a scrap may occur. The defective fall of a scrap means that a scrap remains inside the press apparatus by an unexpected falling motion. The defective fall of a scrap constitutes a possible cause of defective products in the subsequent processing of the press products and a possible cause of damage to the press die.

To address such an issue, there has been developed a technique of simulating a falling motion of a scrap into a scrap chute, when designing a press apparatus.

For example, Japanese Unexamined Patent Application Publication (JP-A) No. 2022-146544 discloses a simulation method including: virtually creating, in a computer, a press apparatus and a scrap to be cut off from a pressed workpiece; and virtually reproducing a motion of the scrap falling into a scrap chute and discharged to the outside.

In this simulation method, the simulation of the falling motion is repeated many times while changing a force to be applied to the scrap at the time of the fall, to calculate probability that the scrap is discharged to the outside through the scrap chute, that is, a scrap discharge ratio. Based on the discharge ratio, a determination is made as to whether design quality of the press apparatus is adequate.

### SUMMARY

An aspect of the disclosure provides an acquisition method of image data to be used in a suitability determination of a defective fall of a scrap cut off from a workpiece processed by a press die. The acquisition method causes a computer to perform simulation of operation in which a plurality of the scraps cut off from the workpiece are discharged to outside the press die through a scrap chute. The simulation includes: disposing cameras with respect to the respective scraps, in which the cameras are configured to capture the respective scraps; and before each of the scraps is discharged to outside the scrap chute, when a speed of any one of the scraps becomes zero, allowing an associated one of the cameras with the relevant one of the scraps to capture the relevant one of the scraps, and allowing the computer to acquire the image data regarding the relevant one of the scraps.

An aspect of the disclosure provides a creation method of a learned model using image data to be used in a suitability determination of a defective fall of a scrap cut off from a workpiece processed by a press die. The image data is acquired by an acquisition method. The acquisition method causes a computer to perform simulation of operation in which a plurality of the scraps cut off from the workpiece are discharged to outside the press die through a scrap chute. The simulation includes: disposing cameras with respect to the respective scraps, in which the cameras are configured to capture the respective scraps; and before each of the scraps is discharged to outside the scrap chute, when a speed of any one of the scraps becomes zero, allowing an associated one of the cameras with the relevant one of the scraps to capture the relevant one of the scraps, and allowing the computer to acquire the image data regarding the relevant one of the scraps. The creation method includes obtaining learning data by accepting annotation of the image data as to whether the defective fall is practically plausible or whether the defective fall is practically unplausible, and creating the learned model based on the learning data.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a schematic diagram of a press apparatus.

FIG. 2 is a block diagram of a hardware configuration of a simulation device.

FIG. 3 is a block diagram of the simulation device.

FIG. 4 is a perspective view illustrating a part of the press apparatus to be displayed in simulation.

FIG. 5 illustrates a random force to be allowed to act on a scrap.

FIG. 6A is a flowchart of a procedure of simulation processing.

FIG. 6B is a flowchart of the procedure of the simulation processing.

FIG. 7A illustrates a fall of a scrap and a movement of a camera.

FIG. 7B illustrates the fall of the scrap and the movement of the camera.

FIG. 7C illustrates the fall of the scrap and the movement of the camera.

FIG. 8A illustrates an unplausible defective fall of a scrap.

FIG. 8B illustrates the unplausible defective fall of the scrap.

FIG. 8C illustrates the unplausible defective fall of the scrap.

### DETAILED DESCRIPTION

To suppress a decline in a data processing speed of the computer, the simulation method described in JP-A No. 2022-146544 includes reducing a frame rate, i.e., the number of images per second, or giving little consideration to operation of an upper die of the press die. Thus, in the simulation, a defective fall of a scrap may occur that is unplausible in an actual press die. For example, because of the small number of images, a situation may occur in which the scrap eats into the scrap chute. In another example, because no upper die is assumed, a situation may occur in which the scrap gets on an upper surface of a lower die.

When calculating the scrap discharge ratio, including in the calculation not only practically plausible defective falls of scraps but also practically unplausible defective falls of scraps may result in lowered accuracy of the scrap discharge ratio calculated. In the following, a practically plausible defective fall is also referred to as a “suitable defective fall” and a practically unplausible defective fall is also referred to as an “unsuitable defective fall.” What is desired to enhance the accuracy of the scrap discharge ratio is for the computer to automatically detect the suitable defective fall and the unsuitable defective fall, that is, to accurately determine whether the defective fall is suitable. In the following, making a determination as to whether the defective fall of the scrap is suitable is also referred to as a suitability determination of the defective fall.

One of the possible methods for the computer to make the suitability determination of the defective fall is a detection method utilizing image recognition by artificial intelligence. In the following, artificial intelligence is abbreviated to “AI.” The image recognition by the AI needs high-quality image data to be used for machine learning to automatically determine whether the defective fall is suitable or whether the defective fall is unsuitable.

However, in an actual press die, a plurality of scraps is cut off from one workpiece. Each scrap is discharged to the outside of the press apparatus through the scrap chute in a short time. It is not easy to grasp a falling motion of each scrap and to acquire image data suitable for AI machine learning, to make the suitability determination of the defective fall of each scrap.

It is desirable to provide an acquisition method of image data that makes it possible to acquire high-quality image data indicating a defective fall of a scrap, and a creation method of a learned model using the image data acquired by the acquisition method.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

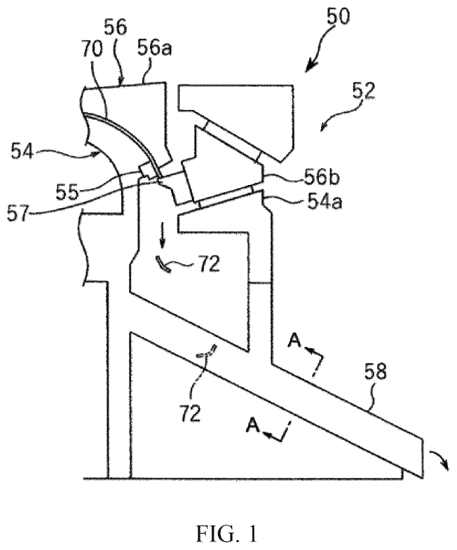

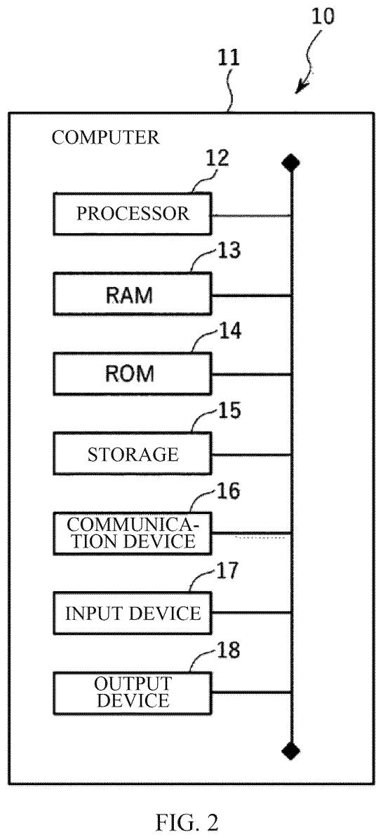

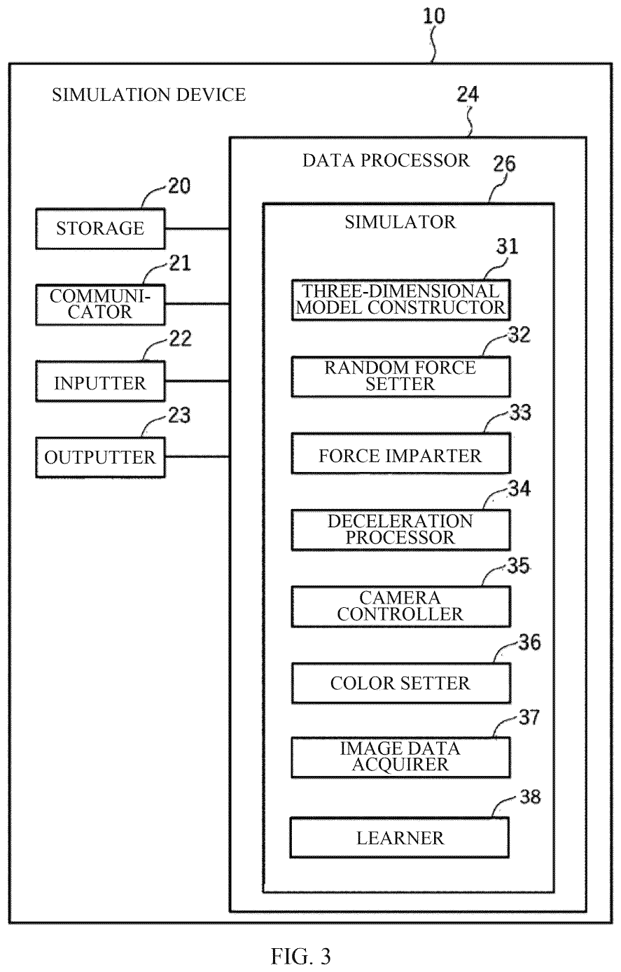

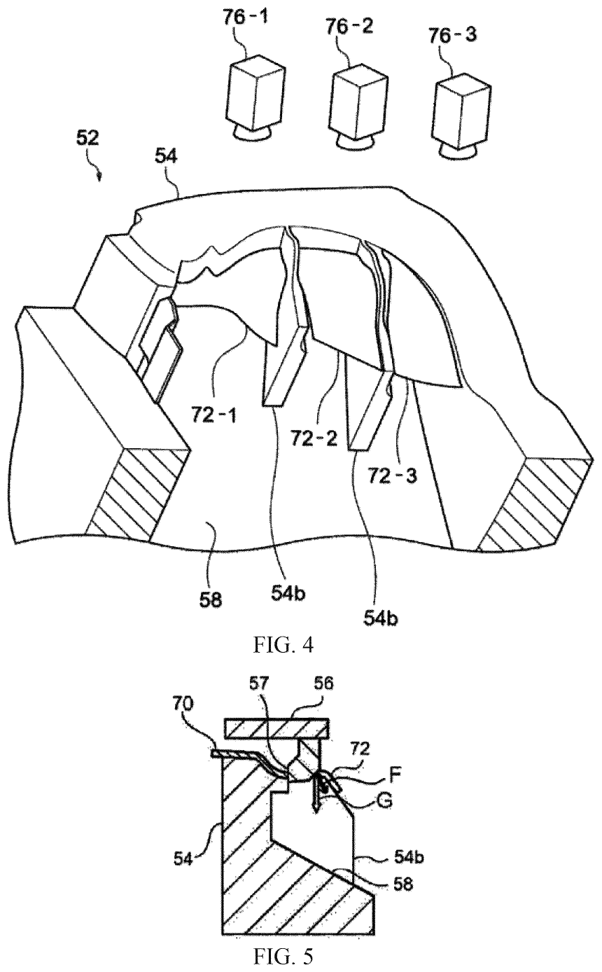

FIG. 1 is a schematic diagram of a press apparatus 50. FIG. 2 is a block diagram of a hardware configuration of a simulation device 10. FIG. 3 is a block diagram of the simulation device 10. In an acquisition method of image data according to an embodiment of the disclosure, the image data is acquired using simulation to be performed by the simulation device 10. The simulation includes simulation of motions of a plurality of scraps 72 generated in a press die 52 and discharged to the outside of the press die 52 through a scrap chute 58. As illustrated in FIG. 4, the image data to be used in a suitability determination of a defective fall of the scrap 72 may be acquired by a plurality of cameras 76 disposed in the simulation. The cameras 76 are virtual cameras. Within the image data by the cameras 76, image data indicating the defective fall of the scrap 72 serves as the image data to be used in the suitability determination of the defective fall of the scrap 72. In the following, the press apparatus 50 and the simulation device 10 are described in detail.

The press apparatus 50 is configured to press a workpiece 70 as a plate material and perform trimming to cut off a scrap portion from the workpiece 70. The press apparatus 50 may include the press die 52 and the scrap chute 58. The scrap chute 58 is provided on the press die 52 and configured to lead the scrap 72 cut off from the workpiece 70 to the outside of the press die 52.

The press die 52 is configured to perform pressing and trimming on the workpiece 70. The press die 52 may include a lower die 54 and an upper die 56. The lower die 54 is fixed to an installation site. The upper die 56 is vertically movable with respect to the lower die 54. The lower die 54 may include a lower cutting edge 55 supported by a lower die body. The upper die 56 may include a pad 56a, a cam slider 56b, and an upper cutting edge 57. The pad 56a may hold the workpiece 70 placed on the lower die 54. The cam slider 56b comes into contact with a cam driver 54a provided in the lower die body, by a descending motion of the upper die 56, moves forward toward the workpiece 70, and moves backward away from the workpiece 70 by an ascending motion of the upper die 56. The upper cutting edge 57 is provided on the cam slider 56b to face the lower cutting edge 55. The workpiece 70 is cut by the upper cutting edge 57 and the lower cutting edge 55 of the press die 52, and a cut portion of the workpiece 70 falls as the scrap 72 into the scrap chute 58 of the press apparatus 50.

The scrap chute 58 is disposed under the lower cutting edge 55 of the press die 52, and include a scrap discharge port. The scrap chute 58 extends obliquely with respect to a horizontal direction to go down toward the scrap discharge port. In the example illustrated in the figure, the scrap chute 58 and the lower die body are integrated. The scrap chute 58 may include a pair of sidewalls and a bottom wall. The sidewalls are disposed at a predetermined interval in a widthwise direction. The bottom wall couples lower edges of the sidewalls. The top side of the scrap chute 58 is open. The scrap 72 slides along an upper surface of the bottom wall downward in a direction of inclination, and is discharged to the outside of the press apparatus 50. In the simulation of the falling motion of the scrap 72 by the simulation device 10, setting may be provided in which little consideration is given to operation of the upper die 56 to enhance a processing speed of the computer 11.

Description is given next of the simulation device 10 to implement the acquisition method of the image data according to an embodiment of the disclosure. As illustrated in FIG. 2, the simulation device 10 may include a computer 11 having a known hardware configuration. The computer 11 may include a processor 12, a RAM (Random Access Memory) 13, a ROM (Read Only Memory) 14, a storage 15, a communication device 16, an input device 17, and an output device 18.

The processor 12 may execute an operating system and an application program. The storage 15 may include a known storage device that holds data such as an HDD (Hard Disk Drive) or an SSD (Solid State Drive). The communication device 16 may include a transmission/reception device to establish communication between the computers 11 through one or both of a wired network and a wireless network. The communication device 16 may include, for example, a network device, a network controller, a network card, a wireless communication module, and the like. The input device 17 may include a keyboard, a mouse, a touchscreen, a microphone, and the like. The output device 18 may include a display, a speaker, and the like.

As illustrated in FIG. 3, the simulation device 10 may include a storage 20, a communicator 21, an inputter 22, an outputter 23, and a data processor 24.

The storage 20 may include the storage 15, and hold data to be involved in performing the simulation, image data obtained by the simulation, and the like. The communicator 21 may include the communication device 16, and allow for data transmission/reception to and from a device external to the simulation device 10. The data to be held in the storage 20 may include programs to perform the simulation. The programs may be recorded in a tangible recording medium such as a CD-ROM, a DVD-ROM, or a semiconductor memory, and provided in the form of the tangible recording medium. Alternatively, the programs may be provided as data signals through the communicator 21. The inputter 22 may include the input device 17 and acquire information inputted by a user. The outputter 23 may include the output device 18 and output information to the user. The outputter 23 may output the information as an image, text, and a sound to help the user to recognize the information using the visual or auditory sense.

The data processor 24 may include a simulator 26. The data processor 24 may include the processor 12, and the simulator 26 may include software to be executed by the processor 12. The simulator 26 is configured to perform, on the computer 11, the simulation including making the scrap 72 fall into the scrap chute 58. The simulator 26 may include a three-dimensional model constructor 31, a random force setter 32, a force imparter 33, a deceleration processor 34, a camera controller 35, a color setter 36, an image data acquirer 37, and a learner 38.

The three-dimensional model constructor 31 reads morphological data regarding the press die 52 including the scrap chute 58, the workpiece 70, and the scrap 72, and construct a three-dimensional model of them. The morphological data may be acquired through the inputter 22. In the embodiment, the three-dimensional model may be created using CAD data to be used in designing the press apparatus 50 and the workpiece 70. The three-dimensional model may include, for example, a three-dimensional mesh model that represents a shape of the press die 52 and a shape of the workpiece 70 by a polygon mesh.

The random force setter 32 may set a force F of random magnitude within a range of predetermined magnitude. The force F is to be allowed to act on the scrap 72 at an initial stage of the fall of the scrap 72. In the following, the force F of the random magnitude is also referred to as a “random force F.” The random force F may be represented by a random function given by the following Expression 1.

$$Force = ( upper limit value , lower limit value ) \qquad Expression 1$$

In the embodiment, as given by the following Expressions 2, 3, and 4, the random force F may be set for each of an X direction, a Y direction, and a Z direction that are orthogonal to each other.

$$Force in X direction = random ( upper limit value xup , lower limit value xlow ) \qquad Expression 2$$

$$Force in Y direction = random ( upper limit value yup , lower limit value ylow ) \qquad Expression 3$$

$$Force in Z direction = random ( upper limit value zup , lower limit value zlow ) \qquad Expression 4$$

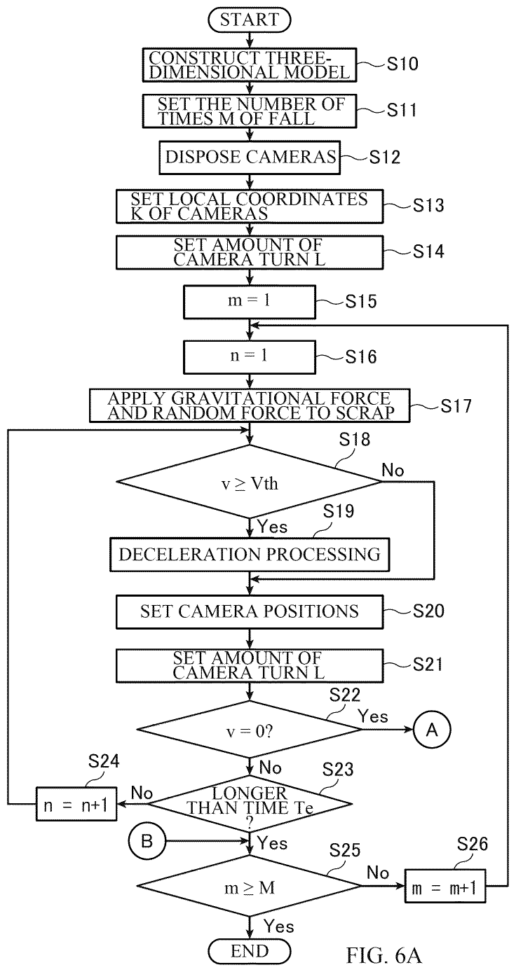

In the embodiment, for example, the positive direction in the Y direction is set as the direction of the gravitational force, and the lower limit value ylow is set to zero (ylow=0). The upper limit value xup, the upper limit value yup, and the upper limit value zup are set to positive values, and the lower limit value xlow and the lower limit value zlow are set to negative values. The random force F to be allowed to act on the scrap 72 is a composite force of the forces in the X direction, the Y direction, and the Z direction set by Expressions 2 to 4. As illustrated in FIG. 5, the range of the magnitude of the random force F may be set to allow the random force F to be smaller than the magnitude of the gravitational force G that acts on the scrap 72.

The force imparter 33 may allow the gravitational force G and the random force F set by the random force setter 32 to act on the scrap 72. The random force F may be imparted at the initial stage of the fall of the scrap 72 when the scrap 72 is cut off from the workpiece 70.

The deceleration processor 34 may perform deceleration processing of the scrap 72 when a falling speed v of the scrap 72 becomes higher than a predetermined threshold value vth. In the following, the predetermined threshold value vth is also referred to as a “speed threshold value vth.” The deceleration processing may be performed in accordance with a preset rule. In the embodiment, when the falling speed v of the scrap 72 becomes higher than the speed threshold value vth, a process of halving the magnitude of the falling speed v of the scrap 72 may be performed as given by the following Expression 5, and the falling speed v′ after the deceleration processing may be set as the current falling speed v.

$$Falling speed after deceleration processing {v}^{′} = v / 2 \qquad Expression 5$$

The camera controller 35 may control the cameras 76 disposed in the simulation. Setting data and control data regarding the cameras 76 may be inputted to the computer 11 by the user through the inputter 22. In the embodiment, in the simulation, setting may be provided in which the cameras 76 are disposed with respect to their respective scraps 72 cut off from the workpiece 70, to allow the cameras 76 to capture their respective scraps 72.

FIG. 4 is a perspective view of a part of the press apparatus 50 to be displayed in the simulation. FIG. 4 illustrates a portion of the lower die 54 of the press apparatus 50 and the scrap chute 58 integrated with the lower die 54. FIG. 4 also illustrates the scrap 72 falling into the scrap chute 58. For example, when a scrap portion to be cut off from the workpiece 70 is large, as illustrated in FIG. 4, the scrap portion is divided into a plurality and removed. The scrap portion is supported from below by supports 54b until the scrap portion is cut off from the workpiece 70 by the upper cutting edge 57 in FIG. 1. The supports 54b are provided on the lower die 54. FIG. 4 illustrates, for example, the two supports 54b protruding from a bottom surface of the scrap chute 58.

In the example of the simulation in FIG. 4, the three cameras 76-1, 76-2, and 76-3 are disposed respectively with respect to the three scraps 72-1, 72-2, and 72-3. Each of the cameras 76 may include a virtual camera disposed in the simulation. The cameras 76 may be disposed by the camera controller 35 in corresponding relation to the respective scraps 72, before the scraps 72 are allowed to fall. For example, in the embodiment, the disposition of the cameras 76 with respect to the respective scraps 72 may be set to acquire the image data captured from above in the vertical direction at a predetermined distance away from the scraps 72. In one example, in world coordinates having the X direction, the Y direction, and the Z direction defined in the simulation, the positional coordinates of the cameras 76 may be set as follows: the coordinates of the cameras 76 in the X direction and the Z direction match with the coordinates of the centers of gravity of the scraps 72; and the coordinates of the cameras 76 in the Y direction as the vertical direction are located upward in the vertical direction by the predetermined distance, e.g., 2 meters, from the center of gravity of the scraps 72. Each of the cameras 76 may be set to move following the falling motion of an associated one of the scraps 72. In the embodiment, the positional coordinates of the cameras 76 disposed in the corresponding relation to the respective scraps 72 may be set to be constant in local coordinates with reference to the positions of the centers of gravity of the respective scraps 72. It is to be noted that the two or more cameras 76 may be disposed with respect to the single scrap 72 with different angles of view. In such a case, each of the cameras disposed with respect to the single scrap 72 may be set to move following the relevant scrap 72. In this specification, description is given assuming the three scraps 72, but four or more scraps 72 may be present in practice. For example, when processing a side panel of an automobile, about twenty scraps may be targeted.

The camera controller 35 may make a switching control of the cameras 76 between an active state and an inactive state. In the active state, the cameras 76 are available to perform imaging. In the inactive state, the cameras 76 are unavailable to perform the imaging. The cameras 76 are also configured to capture a moving image of a process of the fall of the scrap 72. However, moving image data needs a larger capacity and causes a decline in a processing speed, as compared with still image data. Accordingly, in the embodiment, the cameras 76 may be set, by the camera controller 35, to the inactive state at an initial stage of the fall of the scrap 72. The camera controller 35 may control the cameras 76, before each of the scraps 72 falls and is discharged to the outside, when the speed of any one of the scraps 72 becomes zero, to switch an associated one of the cameras 76 with the relevant one of the scraps 72 from the inactive state to the active state and perform the imaging.

Each of the cameras 76 may be set to show exclusively the single, associated one of the scraps 72. For example, in the example in FIG. 4, possibility is that the scrap 72-1 and the adjacent scrap 72-2 are shown in an image to be captured by the camera 76-1. The scrap 72-1 is associated with the camera 76-1 but the adjacent scrap 72-2 is not associated with the camera 76-1. In such a situation, setting may be provided by the user to allow the camera 76-1 to show exclusively the associated scrap 72-1 in the image to be captured by the camera 76-1. In the embodiment, such setting may be provided, in the simulation, using, for example, a game development engine incorporating an IDE (Integrated Development Environment). In the game development engine, by designating, for each layer, which object to be shown in the camera 76, it is possible to provide the setting to allow the single camera 76 to show the single, associated one of the scraps 72. In one example, two layers, e.g., a layer L1 and a layer L2, may be prepared, and the layer L1 may be assumed to be shown in the camera 76, and the layer L2 may be assumed not to be shown in the camera 76. Moreover, the layer L2 may be assumed as a default layer for each scrap 72. After the start of the fall of each scrap 72, layer setting of the scrap 72 whose speed becomes zero may be changed from the layer L2 to the layer L1, allowing the relevant scrap 72 to be shown in the associated one of the cameras 76. Thus, the imaging may be performed by the associated one of the cameras 76 with the relevant scrap 72. After the imaging, the layer setting of the scrap 72 may be changed from the layer L1 to the layer L2, inhibiting the scrap 72 from being shown in the camera 76. This makes it possible to allow the scrap 72 whose speed becomes zero to be shown in the associated one of the cameras 76. When acquiring the image data by the cameras 76, the setting may be provided to allow each of the cameras 76 to show exclusively the single, associated one of the scraps 72. This makes it possible to show the press die 52 including the scrap chute 58, and the single scrap 72-1, in the captured image by the camera 76-1.

The color setter 36 is configured to, when the speed of any one of the scraps 72 becomes zero and the associated one of the cameras 76 performs the imaging before the relevant scrap 72 is discharged to the outside through the scrap chute 58, change the relevant scrap 72 to a predetermined color different from the scrap chute 58. In the simulation, color setting of the scrap 72 and the press apparatus 50 may be provided as appropriate by the color setter 36. For example, in a case where the color of the scrap chute 58 is set to orange and the color of the scrap 72 at the initial stage of the fall is set to green, when the speed of any one of the scraps 72 becomes zero before being discharged to the outside, that is, when a scrap jam occurs, the color setter 36 may change the color of the relevant scrap 72 to the predetermined color, for example, blue. At the initial stage of the fall, the scraps 72 may be set to different colors such as green or yellowish green. However, the color setter 36 may provide the color setting, when the camera 76 captures the defective fall of the scrap 72, to change the colors of the scraps 72 to the same color, e.g., blue in this case.

The image data acquirer 37 is configured to acquire the image data indicating the defective falls of the scraps 72 captured by the respective cameras 76, and store the image data in the storage 20. In the embodiment, the camera controller 35 may control each of the cameras 76 to switch to the active state only when the falling speed of the associated one of the scraps 72 becomes zero and the defective fall occurs. The image data captured at this occasion may be stored in the storage 20 as the image data indicating the defective fall. When the camera 76 captures a moving image of the falling motion of the scrap 72, for example, an image obtained when the color of the scrap 72 is changed to the predetermined color by the color setter 36 may be acquired as the image data indicating the defective fall of the scrap 72. The image data indicating the defective fall of the scrap 72 may be stored in a predetermined storage region of the storage 20. By inputting an output instruction of the image data through the inputter 22, it is possible for the user to output the image data held in the storage 20 to the outputter 23.

The learner 38 may create a learned model by performing machine learning based on learning data obtained by accepting annotation, by a creator of the learned model, of the image data acquired by the image data acquirer 37. The learner 38 may be configured to include, for example, a neural network as a model of data processing simulating how a neural network in a human brain works.

The simulation device 10 may include the single computer 11, or alternatively, the simulation device 10 may include a plurality of the computers 11. When the simulation device 10 includes the computers 11, the computers 11 may be coupled together through a communication network such as the Internet or an intranet.

In the simulation device 10 described above, the computer 11 may be supplied, through the inputter 22, with various kinds of the morphological data and calculation condition data. The morphological data may include the morphological data regarding the press apparatus 50 including the scrap chute 58, the workpiece 70, and the scrap 72. The calculation condition data may include a pressurizing force of the press die 52, falling time Te of the scrap 72, e.g., 4 seconds, the number of frames N of scenes obtained by equally dividing the falling time Te in which N is an integer of 2 or more, the upper limit value and the lower limit value of the random function described above, the magnitude of the gravitational force G, a condition of a reaction force received from the scrap chute 58 when the scrap 72 comes into contact with the scrap chute 58, and the like.

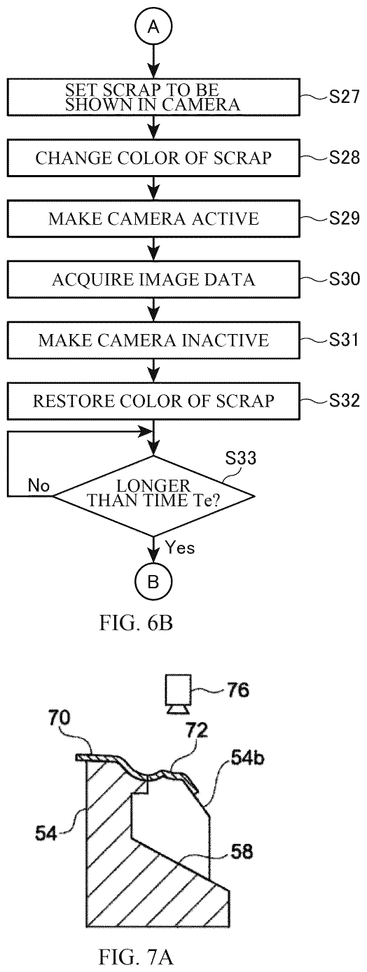

Description now moves on to simulation processing of the falling motion of the scrap 72. The simulation processing is to be performed on the computer 11 by the simulator 26 of the simulation device 10. FIGS. 6A and 6B are flowcharts of a procedure of the simulation processing. First, as illustrated in FIG. 6A, in step S10, the three-dimensional model constructor 31 may create the three-dimensional model of the press apparatus 50 including the scrap chute 58, the workpiece 70, and the scraps 72 based on the morphological data inputted to the computer 11. Thereafter, in step S11, the number of times M the scrap 72 is allowed to fall in the simulation may be set. The number of times M is an integer of 1 or more.

Thereafter, in step S12, before allowing the scraps 72 cut off from the workpiece 70 to fall, the cameras 76 to capture the associated scraps 72 may be disposed with respect to the respective scraps 72.

Thereafter, in step S13, the local coordinates K of the cameras 76 may be set. As described above, in the embodiment, the local coordinates K are relative coordinates for the cameras 76 with reference to the associated scraps 72.

Thereafter, in step S14, an amount of turn L of the camera 76 may be set. In the embodiment, the amount of turn L may be set to direct each camera 76 downward in the vertical direction.

Thereafter, in step S15, the number of the falls m of the scrap 72 may be set to 1 (m=1). Thereafter, in step S16, a scene “n=1” may be set with respect to the falling motion of the scrap 72. Here, n is an ordinal number of each scene of the number of frames N read as the calculation condition data, and is an integer of 1 to N. In the embodiment, the scene “1” may be set to a scene in which the scrap 72 is generated by cutting the workpiece 70, that is, a scene at the initial stage of the fall of the scrap 72.

Thereafter, in step S17, the force to be allowed to act on the scrap 72 at the initial stage of the fall of the scrap 72 may be set. In the embodiment, the random force F may be set by the random force setter 32, based on the random function given by Expressions 2 to 4 mentioned above. The setting may be provided to allow the gravitational force G and the random force F to act on the scrap 72 at the initial stage of the fall.

Thereafter, in step S18, a determination may be made as to whether the falling speed v of the scrap 72 is higher than the predetermined speed threshold value vth. When the falling speed v of the scrap 72 is higher than the speed threshold value vth, the flow may proceed to step S19 and the deceleration processing of the falling speed v may be performed by the deceleration processor 34. In step S18, when the falling speed v is equal to or lower than the speed threshold value vth, the flow may proceed to step S20 without performing the deceleration processing.

Thereafter, in step S20, the positions of the cameras 76 may be set. The positions of the cameras 76, that is, the positional coordinates of the cameras 76 in the world coordinates may be set by the camera controller 35 to allow the local coordinates of the cameras 76 to be equal to the local coordinates K set in step S13 with respect to the scraps 72 that have moved by the falling motion. Thus, the positional relation between the scraps 72 and the associated cameras 76 may be kept constant.

Thereafter, in step S21, the amount of turn L of the camera 76 may be set. The amount of turn L of the camera 76 may be set, by the camera controller 35, to an equal value to the amount of turn L set in step S14, to allow the camera 76 to be directed in a constant direction. In this example, the amount of turn L of the camera 76 may be set to direct the camera 76 downward in the vertical direction. In the embodiment, in steps S20 and S21, the positions and the amount of turn of the camera 76 with respect to the associated scrap 72 may be set in each scene “n.” Thus, the position and the direction of the camera 76 with respect to the scrap 72 may be kept constant from the start to the end of the fall of the scrap 72.

Thereafter, in step S22, a determination may be made as to whether the speed of the scrap 72 is zero. In step S22, when the speed of the scrap 72 is not zero (step S22: No), the flow may proceed to step S23. In step S23, a determination may be made as to whether falling time of the scrap 72 is longer than the set falling time Te.

In step S23, when the falling time Te has not elapsed (step S23: No), the flow may proceed to step S24, and after the scene “n” is counter-processed, the flow may continue again from step S18. In step S23, when the time Te has elapsed (step S23: Yes), the flow may proceed to step S25, a determination may be made as to whether the number of the falls m is equal to or larger than the number of times M set in step S11. When the number of the falls m is smaller than the number of times M (step S25: No), the flow may proceed to step S26, and after the number of the falls m is counter-processed, the flow may continue again from step S16. In step S25, when the number of the falls m is equal to or larger than the number of times M (step S25: Yes), the simulation may end.

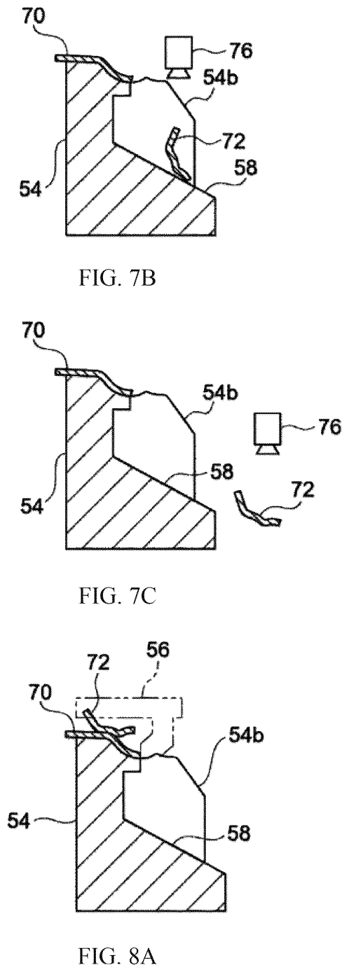

FIGS. 7A, 7B, and 7C illustrate the fall of the scrap 72 and the movement of the camera 76, and illustrate a process in which the scrap 72 falls into the scrap chute 58 and is discharged to the outside. In the simulation processing, each time the scene “n” is counter-processed and a position of the fall of the scrap 72 changes, the position of the camera 76 also changes. This keeps constant relative positional relation between the scrap 72 and the camera 76.

In step S22 described above, when the speed of the scrap 72 is zero (step S22: Yes), the flow may proceed to step S27 in FIG. 6B. In step S27, the scrap 72 to be shown in the camera 76 may be set. In the embodiment, the camera controller 35 may set each of the cameras 76 to show exclusively the single, associated one of the scraps 72 with the relevant camera 76. Before the setting in step S27 is made, the camera controller 35 may set each of the cameras 76 not to capture any scraps 72, or alternatively, the camera controller 35 may set each of the cameras 76 to capture all the scraps 72 within an imaging range of the camera 76. In another alternative, in the setting at the initial stage of the fall, the camera controller 35 may set each of the cameras 76 to show exclusively the single, associated one of the scraps 72. In such a case, the process in step S27 may be omitted.

Thereafter, in step S28, the color setter 36 may change the color of the scrap 72 to the predetermined color set in advance. In the embodiment, the color change may be made, to turn blue the scrap 72 of which the speed becomes zero because of the defective fall.

Thereafter, in step S29, the camera controller 35 may switch the camera 76 provided for the scrap 72 of which the speed becomes zero from the inactive state to the active state. Thereafter, in step S30, the camera 76 in the active state may capture the associated scrap 72, and thereby, the computer 11 may acquire the image data. The captured image data indicating the defective fall of the scrap 72 may be stored in the storage 20 by the image data acquirer 37.

Thereafter, in step S31, the camera controller 35 may switch the camera 76 after the capture from the active state to the inactive state. Thereafter, in step S32, the color setter 36 may restore the original color of the scrap 72 from the predetermined color, and the original setting of the scrap 72 to be shown in the camera 76 may be restored from the setting changed in step S27. After the process in step S32, the simulator 26 may cause the flow to proceed to step S33. In step S33, a determination may be made as to whether the falling time of the scrap 72 is longer than the set falling time Te. After the elapse of the falling time Te (step S33: Yes), the flow may proceed to step S25 in FIG. 6A, and the subsequent processing may be continued.

In the simulation processing described above, the processing with respect to the scraps 72 and the cameras 76 may be individually performed for each scrap 72 and for each camera 76.

The simulation described above of the falling motion of the scrap 72 may be performed as preliminary simulation prior to the simulation of the falling motion of the scrap to be performed for design of an actual press die. In this preliminary simulation, as described above, the dedicated camera 76 configured to capture the single, associated one of the scraps 72 may be disposed for each of the scraps 72 cut off from the workpiece 70. The cameras 76 may move following their respectively associated scraps 72. Each camera 76 may individually capture the scrap 72 when the speed of the scrap 72 becomes zero before the scrap 72 is discharged to the outside. By the individual capture in this preliminary simulation, the image data based on the individual capture of a final state of the fall of the scrap cut off may be obtained.

With the image data thus obtained, it is easy to determine whether the final state of the fall is a practically plausible defective fall that possibly occurs in reality, such as the scrap chute 58 being clogged up by the stuck scrap 72, or whether the final state of the fall is a practically unplausible defective fall that does not possibly occur in reality, such as the scrap 72 eating into the scrap chute 58.

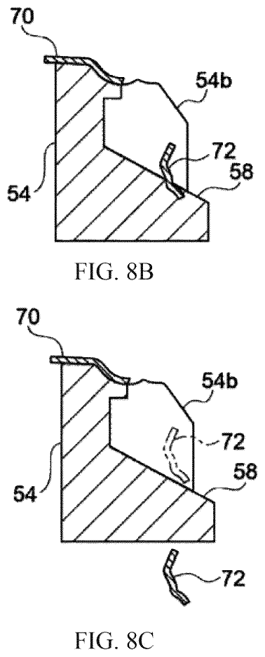

FIGS. 8A, 8B, and 8C illustrate the defective fall of the scrap 72 that occurs in the simulation but is practically unplausible in the actual press die 52. For example, during the fall, the scrap portion of the workpiece 70 may sometimes hit the support 54b and bounce upward. The support 54b supports the scrap portion from below. In the actual press die 52, the bounced scrap 72 hits the upper die 56 and returns toward the scrap chute 58. However, because little consideration is given to the presence or the operation of the upper die 56 to reduce the computational complexity for the simulation by the computer 11, as illustrated in FIG. 8A, the scrap 72 may get on the lower die 54. Further, when a time interval of the calculation of the falling speed of the scrap 72 is increased, that is, the number of frames Nis decreased, to reduce the computational complexity for the simulation, as illustrated in FIG. 8B, the scrap 72 may sometimes eat into the scrap chute 58. When the number of frames N is decreased, as illustrated in FIG. 8C, the scrap 72 at the position indicated by the imaginary line in the scene “n−1” may sometimes pass through the scrap chute 58 in the subsequent scene “n,” such as the scrap 72 indicated by the solid line.

In the acquisition method of the image data in the embodiment, by the dedicated cameras 76 provided for the respective scraps 72, it is possible to capture, from a certain angle of view, not only the practically plausible defective fall but also the unplausible defective fall as illustrated in FIGS. 8A, 8B, and 8C and acquire the image data indicating the defective fall. The image after the individual fall of each scrap 72 makes useful information for the determination as to the suitability of the defective fall. This helps to obtain high-quality image data for the AI machine learning in the simulation of the fall for the design of the actual press die to be performed after the preliminary simulation.

Moreover, in the acquisition method of the image data in the embodiment, it is possible to capture, each time, the scrap 72 in the defective fall from above at the predetermined distance set in advance. Hence, it is possible to enhance the accuracy of the determination as to the suitability of the defective fall of the scrap 72. For example, in the AI machine learning, the information regarding the scrap 72 included in the image data is given as angle-of-view information uniformly from above. This leads to enhancement in learning effects for the AI. Furthermore, the acquired image data includes exclusively the single scrap. Hence, in the machine learning by the AI using the image data, it is possible to enhance the accuracy of the AI recognition of the scrap 72 in the defective fall included in the image data.

In addition, in the acquisition method of the image data in the embodiment, the acquired image data may be held as history information. Hence, it is possible to save the designer of the press die from checking a jam state of the scrap 72 while constantly monitoring the simulation. Moreover, the image data to be used for the machine learning increases in quantity every time the simulation is performed. Hence, it is possible to enhance the accuracy of the learned model by performing the AI machine learning using a large quantity of the acquired image data.

Description is given next, of a creation method of the learned model using the acquisition method of the image data described above. First, the computer 11 may acquire the image data indicating the defective fall of the scrap 72 by the acquisition method of the image data described above. Thereafter, the computer 11 may accept the annotation, by the creator of the learned model, as to whether the acquired image data represents the practically plausible defective fall or whether the acquired image data represents the practically unplausible defective fall. The annotation may be made by the creator by giving annotation data for classification to the image data in the computer 11 through the inputter 22. Thereafter, the learner 38 of the computer 11 may perform the machine learning based on the annotated image data, that is, the learning data.

By using the learned model thus created, it is possible for the computer 11 including the learner 38 as the artificial intelligence to determine whether the defective fall is practically plausible or whether the defective fall is practically unplausible.

The simulation for the design of the press die using the learned model may be made as follows. The data processor 24 of the simulation device 10 may calculate probability that the scrap 72 is appropriately discharged to the outside of the press die 52, based on results of the simulation of the fall of the scrap 72 for M times. M is an integer of 2 or more. For example, let us assume that the number of times M the simulation is made equals 200 (M=200), and the number of times Q the scrap 72 is appropriately discharged to the outside equals 180 (Q=180). That is, the number of times the defective fall of the scrap 72 occurs is 20. In this case, the probability R equals 180/200×100(%). Among the defective falls of the scrap 72, when the number of times I the practically unplausible defective fall occurs is 1 (I=1), the number of times I is excluded from the calculation of the probability. Accordingly, the probability R equals 180/(200−1)×100(%). The data processor 24 of the simulation device 10 may determine that design quality is low when the calculated probability R is lower than a predetermined threshold value Rth. The data processor 24 of the simulation device 10 may determine that the design quality is high when the calculated probability R is equal to or higher than the threshold value Rth. The threshold value Rth may be set appropriately by the inputter 22. A determination result may be outputted to the outputter 23 of the simulation device 10.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

For example, the technology of the disclosure may be realized by the acquisition method of the image data to be used in the suitability determination of the defective fall of the scrap, the creation method of the learned model using the image data acquired by the acquisition method, and the learned model created by the creation method.

The simulation device 10 illustrated in FIG. 2 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the simulation device 10. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the simulation device 10 illustrated in FIG. 2.

1. An acquisition method of image data to be used in a suitability determination of a defective fall of a scrap cut off from a workpiece processed by a press die,
the acquisition method causing a computer to perform simulation of operation in which a plurality of the scraps cut off from the workpiece are discharged to outside the press die through a scrap chute, the simulation comprising:
disposing cameras with respect to the respective scraps, the cameras being configured to capture the respective scraps; and
before each of the scraps is discharged to outside the scrap chute, when a speed of any one of the scraps becomes zero, allowing an associated one of the cameras with the relevant one of the scraps to capture the relevant one of the scraps, and allowing the computer to acquire the image data regarding the relevant one of the scraps.

2. The acquisition method of the image data according to claim 1, wherein
the disposing of the cameras comprises setting the cameras to allow the cameras to acquire the image data captured from above at a predetermined distance away from the respective scraps.

3. The acquisition method of the image data according to claim 1, wherein
the allowing of the computer to acquire the image data comprises setting each of the cameras to show exclusively a single, associated one of the scraps.

4. The acquisition method of the image data according to claim 2, wherein
the allowing of the computer to acquire the image data comprises setting each of the cameras to show exclusively a single, associated one of the scraps.

5. The acquisition method of the image data according to claim 1, wherein
the allowing of the computer to acquire the image data comprises:
setting, at an initial stage of a fall of each of the scraps, the associated one of the cameras to an inactive state in which the relevant one of the cameras is unavailable to perform imaging; and
when the speed of the relevant one of the scraps becomes zero, switching the associated one of the cameras to an active state in which the relevant one of the cameras is available to perform the imaging.

6. The acquisition method of the image data according to claim 2, wherein
the allowing of the computer to acquire the image data comprises:
setting, at an initial stage of a fall of each of the scraps, the associated one of the cameras to an inactive state in which the relevant one of the cameras is unavailable to perform imaging; and
when the speed of the relevant one of the scraps becomes zero, switching the associated one of the cameras to an active state in which the relevant one of the cameras is available to perform the imaging.

7. A creation method of a learned model using image data acquired by the acquisition method according to claim 1,
the creation method comprising
obtaining learning data by accepting annotation of the image data as to whether the defective fall is practically plausible or whether the defective fall is practically unplausible, and
creating the learned model based on the learning data.

8. A creation method of a learned model using image data acquired by the acquisition method according to claim 2,
the creation method comprising
obtaining learning data by accepting annotation of the image data as to whether the defective fall is practically plausible or whether the defective fall is practically unplausible, and
creating the learned model based on the learning data.

9. A creation method of a learned model using image data to be used in a suitability determination of a defective fall of a scrap cut off from a workpiece processed by a press die, the image data being acquired by an acquisition method causing a computer to perform simulation of operation in which a plurality of the scraps cut off from the workpiece are discharged to outside the press die through a scrap chute, the simulation comprising:
disposing cameras with respect to the respective scraps, the cameras being configured to capture the respective scraps; and
before each of the scraps is discharged to outside the scrap chute, when a speed of any one of the scraps becomes zero, allowing an associated one of the cameras with the relevant one of the scraps to capture the relevant one of the scraps, and allowing the computer to acquire the image data regarding the relevant one of the scraps,
the creation method comprising
obtaining learning data by accepting annotation of the image data as to whether the defective fall is practically plausible or whether the defective fall is practically unplausible, and
creating the learned model based on the learning data.
